(19) United States
(12) Patent Application Publication
(10) Pub. No.: US 2007/0260966 A1
(43) Pub. Date: Nov. 8, 2007

(54) Error Correction Method and Apparatus for Low Density Parity Check

(76) Inventors: Ki-Hyun Kim, Seongnam (KR); Yoon-Woo Lee, Suwon (KR); Hyun-Jung Kim, Suwon (KR)

Correspondence Address: STEIN, MCEWEN & BUI, LLP, 1400 EYE STREET, NW, SUITE 300, WASHINGTON, DC, 20005, US

(21) Appl. No.: 10/580,844

(22) PCT Filed: Nov. 26, 2004
(86) PCT No.: PCT/KR04/03079

§ 371 Date: Mar. 12, 2007

(30) Foreign Application Priority Data
Nov. 28, 2003 (KR) 10-2003-0085769

(51) Int. Cl. G06F 11/10

(52) U.S. Cl. 714/800

(57) ABSTRACT

An apparatus for and a method of correcting an error using a low density parity check (LDPC) matrix. A resultant matrix is generated by performing XOR and modular 2 operations with respect to the LDPC matrix and a code word vector and a number of 1 bits in the resultant matrix is detected. If the number of 1 bits and a column weight of the LDPC matrix are equal, a column of the LDPC matrix having bit values corresponding to bit values of the resultant matrix, respectively, is identified and the codeword is corrected by changing a binary value of a bit of the code word vector having a bit number corresponding to the identified column number. Otherwise the error correction is terminated without correcting the error.

### TECHNICAL FIELD

The present invention relates to an error correction method and apparatus, and more particularly, to an error correction method and apparatus for determining whether an error exists in a decoded binary signal and correcting the error if the error exists in a decoding apparatus using a low density parity check (LDPC).

### BACKGROUND ART

A low density parity check (LDPC) encoding and decoding method refers to an error correction encoding and decoding technology used in a wireless communication field and an optical recording/reproducing field. An LDPC encoding includes a process of generating parity information using a parity check matrix. Here, most components of the parity check matrix are 0, and very sparse components of the parity check matrix are 1.

The LDPC encoding is divided into a regular LDPC encoding and an irregular LDPC encoding. In the regular LDPC encoding, the number of components equal to 1 included in a parity check matrix used for encoding and decoding is the same in every row and column. Otherwise, the LDPC encoding is irregular.

The LDPC encoding can be represented as shown in Equation 1.
H×C=0 [Equation 1]

where, H indicates a parity check matrix, 0 indicates a zero matrix, ‘x’ indicates an XOR operation and a modular 2 operation, and C indicates a code word vector, that is, a column matrix indicating a code word to be encoded. The code word includes an x-bit message word x₁, x₂, . . . , xₓ and p-bit parity information p₁, p₂, . . . , pₚ.

The parity information p₁, p₂, . . . , pₚ is generated so that the message word x₁, x₂, . . . , xₓ satisfies Equation 1. That is, since a binary value of the message word to be encoded among components of the parity check matrix H and matrix C is determined, parity information p (i=1, 2, . . . , p) can be determined using Equation 1.

The LPDC decoding can be represented as shown in Equation 2.
H×C_{d}=Z [Equation 2]

where, H indicates the same parity check matrix as that used for the encoding, C_{d} indicates a code word vector after passing a channel, and Z indicates a resultant matrix generated by performing a modular 2 operation on the two matrices. If an original code word is restored by successfully performing the decoding, that is, if C_{c}=C_{d}, the resultant matrix Z will be the zero matrix. That is, it is determined whether the decoding is successful by determining whether all components of the resultant matrix Z are 0.

More detailed descriptions of the LDPC encoding are described in the article, ‘Good Error Correction Codes Based on Very Sparse Matrices’ (D. J. MacKay, IEEE Trans. on Information Theory, vol. 45, no. 2, pp. 399-431, 1999) and ‘Efficient Encoding of Low Density Parity Check Codes’ (T. Richardson, R. Urbanke, IEEE Trans. on Information Theory, vol. 47, no. 2, pp. 638-656, 2001).

However, according to the conventional LPDC decoding method, since the resultant matrix Z cannot be equal to the zero matrix even if an error is generated in only one bit of the decoded code word vector C_{d}, the decoding is determined as a failure. Therefore, the conventional LPDC decoding method is not an efficient decoding method.

### DISCLOSURE OF INVENTION

### Technical Solution

The present invention provides a low density parity check (LDPC) error correction method and apparatus for preventing a small number of errors from causing a total block to be determined as a decoding failure and correcting an error when it is determined that the error is in only one bit.

### Advantageous Effects

according to an LDPC decoding method and apparatus of the present invention, the decoding apparatus using the LDPC can prevent a small number of errors from causing a total block to be determined as a decoding failure and correct an error when it is determined that 1-bit error exists.

### DESCRIPTION OF DRAWINGS

FIG. 1 is a flowchart of an LDPC error correction method according to an embodiment of the present invention;

FIG. 2 is a block diagram of an error correction apparatus according to an embodiment of the present invention;

FIG. 3 illustrates correlations among components of matrices in a regular LDPC decoding;

FIG. 4 illustrates correlations among components of matrices representing a principle of an error determination and correction method according to an embodiment of the present invention; and

FIG. 5 is a flowchart of an error determination and correction method according to an embodiment of the present invention.

### BEST MODE

According to an aspect of the present invention, there is provided a low density parity check (LDPC) error correction method comprising: generating a resultant matrix (m*1) by performing an XOR operation and a modular 2 operation with respect to an LDPC matrix (m*n) and a code word vector (n*1); determining whether a decoding of the code word vector succeeded on the basis of the resultant matrix; and if it is determined that the decoding failed, detecting a code word bit, in which an error is generated, in the code word vector on the basis of correlations of components of the LDPC matrix, the code word vector, and the resultant matrix.

According to another aspect of the present invention, there is provided an error determination method comprising: generating a resultant matrix (m*1) by multiplying an LDPC matrix (m*n) by a code word vector (n*1) and determining whether a decoding of the code word vector succeeded on the basis of the resultant matrix; and if it is determined that the decoding failed, determining again whether the decoding succeeded on the basis of the number of 1s included in the resultant matrix.

According to another aspect of the present invention, there is provided a low density parity check (LDPC) error correction apparatus comprising: a decoding success/failure checking unit generating a resultant matrix (m*1) by performing an XOR operation and a modular 2 operation with respect to an LDPC matrix (m*n) and a code word vector (n*1) and determining whether a decoding of the code word vector succeeded on the basis of the resultant matrix; an error location detector searching the same column vector as the resultant matrix in the LDPC matrix and, if the same column vector exists, detecting an error location by detecting a column number of the same column vector.

### Mode for Invention

Hereinafter, the present invention will now be described more fully with reference to the accompanying drawings, in which embodiments of the invention are shown.

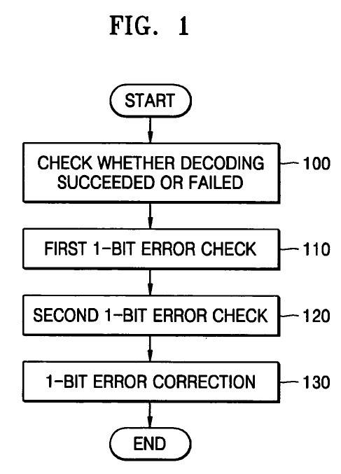

FIG. 1 is a flowchart of an LDPC error correction method awarding to an embodiment of the present invention.

A decoding success/failure check of a decoded code word vector is performed in step 100. This step is performed by determining whether all components of a resultant matrix Z obtained by performing an XOR operation and a modular 2 operation of a parity check matrix H and decoded code word vector C are 0, as in the prior art.

If it is determined that the decoding failed in step 100, that is, if even a single ‘1’ is discovered in the resultant matrix Z, it is determined whether the generated error is a 1-bit error in step 110. A first condition of the 1-bit error is that the number of 1s generated in the resultant matrix Z is the same as the number of 1s included in a column of the parity check matrix H. That is, the first condition of 1-bit error is related to the number of errors. The reason is because a change of a code word bit influences generation of the resultant matrix Z as much as the number of 1s included in a specific column of the parity check matrix H. As a result, if the number of 1s included in the resultant matrix Z is not the same as the number of 1s included in a column of the parity check matrix H, it is determined that the error is not the 1-bit error.

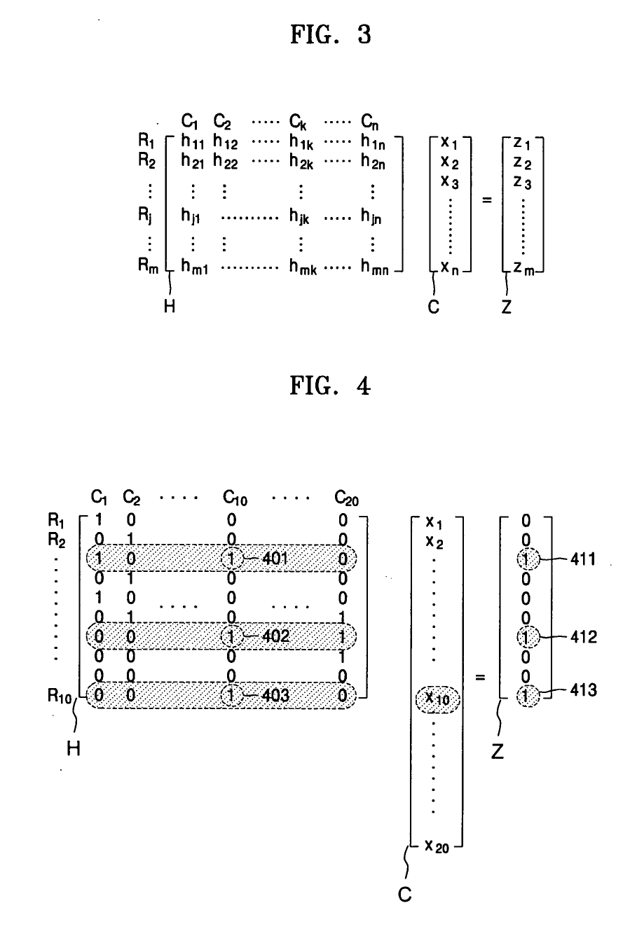

If it is determined that the error is not the 1-bit error in step 110, a decoder (not shown) determines that the decoding failed and finishes the decoding process at the moment. However, if it is determined that the error is the 1-bit error in step 110, it is determined whether the decoded code word vector C satisfies a second condition to be the 1-bit error in step 120. The second condition to be the 1-bit error is that the same column vector as the resultant matrix Z must exist in the parity check matrix H. That is, the second condition to be the 1-bit error is related to an error location. The second condition will be described in detail with reference to FIGS. 3 and 4.

If the two conditions to be the 1-bit error are satisfied in steps 110 and 120, a 1-bit error correction is performed in step 130. The 1-bit error correction is performed by changing binary values of code word bits corresponding to a column number of the column vector detected in step 120 in the code word vector.

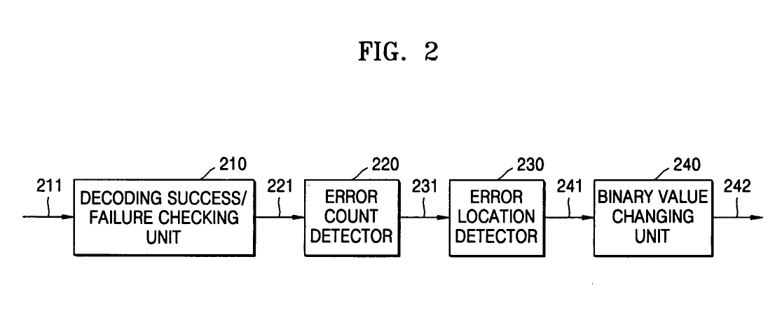

FIG. 2 is a block diagram of an error correction apparatus according to an embodiment of the present invention.

Referring to FIG. 2, the error correction apparatus includes a decoding success/failure checking unit 210, an error count detector 220, an error location detector 230, and a binary value changing unit 240. The decoding success/failure checking unit 210 determines whether a decoding succeeded or failed by generating a resultant matrix Z 221 from a code word vector C 211, which is a decoded binary signal, and a parity check matrix and determining whether all components of the resultant matrix Z 221 are 0.

If it is determined that the decoding failed, the error count detector 220 receives the resultant matrix Z 221, detects the number of 1s included in the resultant matrix Z 221, and determines whether the number of detected 1s is the same as a column weight of the parity check matrix H. If they are the same, the error count detector 220 generates a first condition satisfaction signal 231 and transmits the signal 231 to the error location detector 230. When the error location detector 230 receives the first condition satisfaction signal 231 from the error count detector 220, the error location detector 230 searches whether the same column vector as the resultant matrix Z 221 exists in the parity check matrix H. If the same column vector exists, the error location detector 230 transmits a second condition satisfaction signal 241 and a column number k of the detected column vector to the binary value changing unit 240.

When the binary value changing unit 240 receives the second condition satisfaction signal 241 from the error location detector 230, the binary value changing unit 240 corrects the error by changing a binary value of a code word bit, which has the same number as the column number k of the column vector received from the error location detector 230, in the code word vector C 211.

FIG. 3 illustrates correlations among components of matrices in a regular LDPC decoding.

An LDPC matrix H is an m*n matrix having components h₁₁ through hₘₙ. In a regular LDPC encoding, the number of 1s included in each row R₁, R₂, R₃, . . . , Rₙ is all the same, and also, the number of 1s included in each column C₁, C₂, C₃, . . . , Cₙ is all the same. Here, the number of is included in each row R₁, R₂, R₃, . . . , Rₙ is called a row weight, and the number of 1s included in each column C₁, C₂, C₃, . . . , Cₙ is called a column weight. In a typical regular LDPC encoding, the row weight is 3, and the column weight is usually 9, which is a triple number of the row weight.

In a regular LDPC decoding, each row R₁, R₂, R₃, . . . , Rₙ is different from each other, and each column C₁, C₂, C₃, . . . , Cₙ is also different from each other. That is, R₁¹ R₂¹ R₃¹ . . . ¹Rₙ, also, C₁¹ C₂¹ C₃¹ . . . ¹Cₙ. This feature is used for an error correction that will be described later.

A decoded code word vector C includes code word bits x₁, x₂, x₃, . . . , xₙ including information bit and parity bit. The resultant matrix Z is generated by performing a modular operation of the LDPC matrix H and decoded code word vector C.

Correlations among components of the matrices are represented as shown in Equation 3.
mod 2[h₁₁x₁+h₁₂x₂+ . . . +h₁ₙxₙ]=z₁
mod 2[h₂₁x₁+h₂₂x₂+ . . . +h₂ₙxₙ]=z₂
mod 2[hₘ₁x₁+hₘ₂x₂+ . . . +hₘₙxₙ]=zₘ [Equation 3]

Here, if any one of z₁, z₂, z₃, . . . , zₙ is 1, it is determined that the decoding failed.

FIG. 4 illustrates correlations among components of matrices representing a principle of an error determination and correction method according to an embodiment of the present invention.

Referring to FIG. 4, a column weight (CW) is 3, and a parity check matrix H is a 10*20 matrix. Code word bits x₁, x₂, x₃, . . . , x₂₀ indicates decoded code word bits. A resultant matrix Z is a column vector having 10 components.

In this embodiment, third, seventh, and tenth components of the resultant matrix Z are 1. This resultant matrix Z indicates that the LDPC decoding failed. Now, it is examined that each component of the resultant matrix Z is generated from what components of the parity check matrix H and decoded code word vector C and that the components give what kind of influences to the error. The above things can be known by examining Equation 3.

A first ‘1’ 411 of the resultant matrix Z is generated by performing the modular operation of a third row R3 of the parity check matrix H and the code word column vector. A second ‘1’ 412 of the resultant matrix Z is generated by performing the modular operation of a seventh row R7 of the parity check matrix H and the code word column vector. Likewise, a third ‘1’ 413 of the resultant matrix Z is generated by performing the modular operation of a tenth row R10 of the parity check matrix H and the code word column vector. If the decoded code word vector C was the same as a code word vector C, any ‘1’ would not appear in the resultant matrix Z. However, since at least one ‘1’ appeared in the resultant matrix Z, it can be predicted that binary values of one or more (unknown yet) bits among code word bits of the decoded code word vector C were changed. In the present invention, when only one code word bit is changed, that is, when a 1-bit error is generated, a location where the error is generated is predicted.

It is assumed that an error is generated in one bit of the decoded code word vector C and a location where the error is generated is a tenth code word bit x₁₀ of the decoded code word vector C. In Equation 3, when the resultant matrix Z is generated, the code word bit x₁₀ is modular operated with each bit of a tenth column C₁₀ of the parity check matrix H. However, the code word bit x₁₀ is not modular operated with all bits of the tenth column C₁₀ since there are components having a value 0. That is, the code word bit x₁₀ is modular operated in only locations where ‘1’ exists among components of the tenth column C₁₀, and as a result, only the locations influences the generation of components of the resultant matrix Z. In this embodiment, since the locations where a component of the tenth column C₁₀ is 1 are the third, seventh, and tenth bits, 1s appear in the third, seventh, and tenth locations of the resultant matrix Z.

As a result, if only a 1-bit error is generated, it can be known that column numbers of the parity check matrix H having ‘1’ in the same locations as those where ‘1’ appears in the resultant matrix Z are the same as numbers of code word bits where errors are generated in the decoded code word vector C. However, this proposition is effected under an assumption that the parity check matrix H is a regular LDPC matrix and an error is generated in only one bit of the code word. If the error is not the 1-bit error, since a plurality of code words influence generation of components of the resultant matrix, and since a row of the parity check matrix and the generation of components of the resultant matrix do not have a one-to-one relationship, nobody knows which code word bits influence the generation of the resultant matrix.

As described above, a bit where an error is generated in the code word can be known by examining the resultant matrix. This is performed as follows.

First, bit numbers whose values are 1 in a resultant matrix are detected. In the embodiment of FIG. 4, the bit numbers whose components have 1 in the resultant matrix are 3, 7, and 10.

Second, a column C having 1 in the same locations as those of bits detected in the first procedure in a parity check matrix is searched. In a regular LDPC, since every column of the parity check matrix is different from each other, the searched column is unique. In the embodiment of FIG. 4, the column is C₁₀.

Third, a code word bit having the same number as that of the column obtained in the second procedure is the code word bit where the error is generated. In the embodiment of FIG. 4, the code word bit is x₁₀.

As described above, it is assumed that a 1-bit error is generated and every column of a parity check matrix has the same column weight. Therefore, if the number of bits having 1 in the resultant matrix in the first procedure is not the same as the column weight (for example, the number of bits having 1 in the resultant matrix is 4), the method according to the present invention cannot be adapted.

An LDPC matrix used for optical disc systems usually uses cases where m=1000 through 10000 and n=3000 through 30000. If it is considered that a general bit error rate (BEP) of DVD is 10⁻¹², a proportion of generating errors in two bits or more with respect to one code word vector (3000 through 30000 bits) is way low. Therefore, in general optical disc systems, a very large error correction effect can be achieved with only a 1-bit error correction.

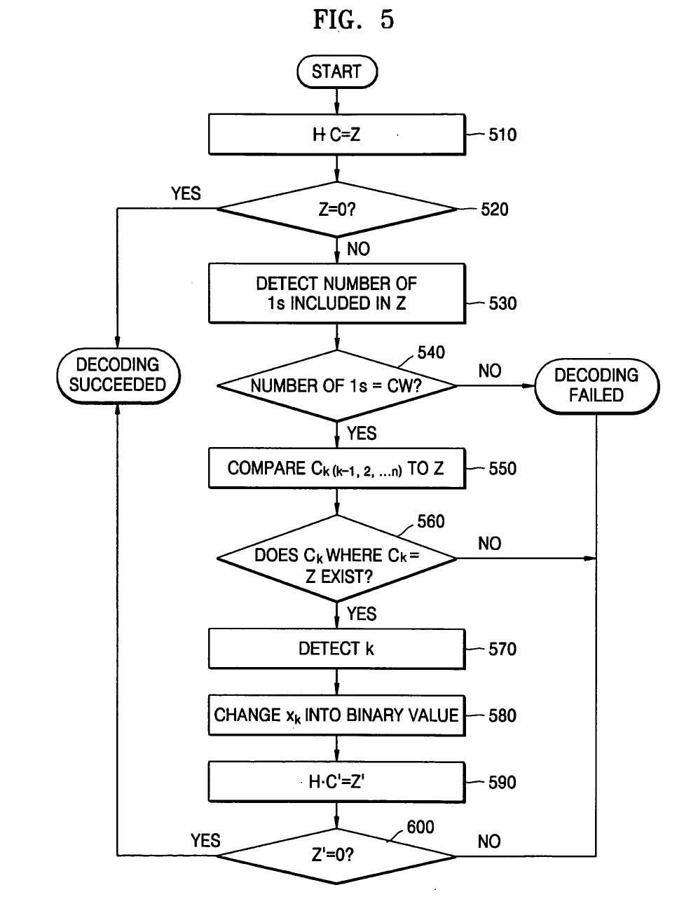

FIG. 5 is a flowchart of an error determination and correction method according to an embodiment of the present invention.

Steps 510 and 520 indicate a procedure of detecting whether an error exists in an encoded code word vector C. The decoding success/failure checking unit 210 generates a resultant matrix Z by multiplying a parity check matrix H used in an encoding process and a decoded code word vector C and modular 2 operating respective components of the two matrices in step 510. The decoding success/failure checking unit 210 checks whether all components of the resultant matrix Z are 0 in step 520. Since the modular 2 operation was performed, if any error was not generated in the decoded code word vector C, all components of the resultant matrix Z should be 0. However, if at least one ‘1’ exists in the components of the resultant matrix Z due to error generation, this process proceeds to step 530.

Steps 530 and 540 indicate a first procedure for determining whether the error generated in the decoded code word vector C is a correctable error according to the present invention, that is, whether the error is a 1-bit error. If it is determined that at least one ‘1’ is included in the components of the resultant matrix Z in step 520, the error count detector 220 detects the number of 1s included in the resultant matrix Z in step 530 and determines whether the number of 1s included in the decided code word vector C is the same as a CW of the parity check matrix H in step 540. If the number of 1s included in the decoded code word vector C is different from the CW of the parity check matrix H in step 540, since the error is not the 1-bit error, it is impossible to correct the error according to the present invention. Accordingly, it is determined that the decoding failed. If the number of 1s included in the decoded code word vector C is the same as the CW of the parity check matrix H in step 540, this process proceeds to step 550.

Steps 550 through 570 indicate a second procedure for determining whether the error generated in the decoded code word vector C is a correctable error according to the present invention, that is, whether the error is a 1-bit error. If it is determined that the number of 1s included in the decoded code word vector C is the same as the CW of the parity check matrix H in step 540, the error location detector 230 compares each column matrix C₁, C₂, C₃, . . . , Cₙ included in the parity check matrix H to the resultant matrix Z in step 550 and determines whether a column matrix Cₖ same as the resultant matrix Z exists in step 560. If the column matrix Cₖ same as the resultant matrix Z does not exist in step 560, since ‘1’ is generated due to a third cause not the 1-bit error, it is impossible to correct the error according to the present invention. Accordingly, it is determined that the decoding failed. If the column matrix Cₖ same as the resultant matrix Z exists in step 560, a column number k of the column matrix Cₖ is extracted in step 570.

The binary value changing unit 240 generates a corrected code word vector C by changing a binary value of the kth code word bit of the decoded code word vector C, that is, changing 0 to 1 or 1 to 0, in step 580. Since every code word bit has only a value 0 or 1, if the error is generated on a value 0, 1 is a value before the error is generated. Accordingly, the binary value changing allows the error corrected.

In steps 590 and 600, the decoding success/failure checking unit 210 confirms whether the correction is achieved by checking on the corrected code word vector C whether the decoding succeeded using the same procedure as steps 510 and 520.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A low density parity check (LDPC) error correction method comprising:
generating an m*1 resultant matrix by performing an XOR operation and a modular 2 operation with respect to an m*n LDPC matrix and an n*1 code word vector;
determining whether a decoding of the code word vector succeeded based on the resultant matrix;
if determined that the decoding failed, detecting a code word bit, in which an error is generated in the code word vector based on correlations of components of the LDPC matrix, the code word vector, and the resultant matrix; and
correcting the error by changing a binary value of the detected code word bit.

2. The method of claim 1, wherein the detecting of the code word bit in which the error is generated comprises:
checking whether a column vector having same bit values as the resultant matrix exists in the LDPC matrix; and
if the column vector having the same bit values as the resultant matrix exists in the LDPC matrix, detecting a code word bit of the code word vector corresponding to a column number of the arched column vector of the LDPC matrix having the same bit values as the resultant matrix to be a code word bit in which an error is generated.

3. The method of claim 2, wherein the detecting of the code word bit in which the error is generated further comprises:
if the column vector having the same bit values as the resultant matrix does not exist in the LDPC matrix, determining that the decoding failed and ending without correcting the generated error.

4. The method of claim 1, further comprising:
detecting a number of generated 1-bit errors based on the number of 1s included in the resultant matrix.

5. The method of claim 4, wherein the detecting the number of generated 1-bit errors comprises:
checking whether the number of 1s included in the resultant matrix is the same as a column weight of the LDPC matrix; and
if the number of 1s included in the resultant matrix is not the same as a column weight of the LDPC matrix, determining that the decoding failed and ending without correcting the error.

6. The method of claim 2, further comprising:
generating a new m*1 resultant matrix by performing the XOR operation and modular 2 operation with respect to the m*n LDPC matrix and a corrected n*1 code word vector in which a binary value of the detected code word bit is changed; and
determining whether decoding of the corrected code word vector succeeded based on the new m*1 resultant matrix.

7. A method of determining an error, comprising: generating an m*b 1 resultant matrix by multiplying an m*n LDPC matrix by an n*1 code word vector and determining whether a decoding of the code word vector succeeded based on the resultant matrix;
and if determined that the decoding failed, determining again whether the decoding succeeded based on a number of 1s included in the resultant matrix.

8. The method of claim 7, further comprising:
determining that the decoding failed if the number of 1s included in the resultant matrix is not equal to a column weight of the LDPC matrix.

9. The method of claim 7, further comprising:
determining whether the decoding succeeded or failed by checking whether a same column matrix as the resultant matrix exists in the LDPC matrix.

10. A low density parity check (LDPC) error correction apparatus comprising:
a decoding success/failure checking unit generating an m*1 resultant matrix by performing an XOR operation and a modular 2 operation with respect to an m*n LDPC matrix and an n*1 code word vector and determining whether a decoding of the code word vector succeeded based on the resultant matrix;
an error location detector searching the LDPC matrix for a same column vector as the resultant matrix and, if the same column vector exists in the LDPC matrix, detecting an error location in the code word vector by detecting a column number of the same column vector; and
a binary value changing unit correcting the error by changing a binary value of a code word bit in the code word vector corresponding to the detected column number.

11. The apparatus of claim 10, wherein:
if the same column vector as the resultant matrix does not exist in the LDPC matrix, the error location detector determines that the decoding failed.

12. The apparatus of claim 10, further comprising:
an error count detector determining whether a number of 1s included in the resultant matrix is the same as a column weight of the LDPC matrix and, if the number of 1s is not equal to the column weight, determining that the decoding failed.

13. A method of correcting a 1 bit error in a code word vector using a low density parity check (LDPC) matrix, the method comprising:
generating a resultant matrix by performing an XOR operation and a modular 2 operation with respect to the LDPC matrix and the code word vector;
identifying a number of a column of the LDPC matrix having bit values corresponding to bit values of the resultant matrix, respectively; and
correcting the codeword by changing a binary value of the bit number of the codeword corresponding to the identified column number of the LDPC matrix.

14. The method of claim 13, further comprising:
determining that the error is not the 1 bit error if the bit values of the resultant matrix do not correspond to the bit values of any column of the LDPC matrix.

15. The method of claim 13, further comprising:
ending the method without correcting the error if the bit values of the resultant matrix do not correspond to the bit values of any column of the LDPC matrix

16. A method of correcting a 1 bit error in a code word vector using a low density parity check (LDPC) matrix, the method comprising:
generating a resultant matrix by performing an XOR operation and a modular 2 operation with respect to the LDPC matrix and the code word vector;
determining whether a number of 1s in the resultant matrix is equal to a column weight of the LDPC matrix;
identifying a number of a column of the LDPC matrix having bit values corresponding to bit values of the resultant matrix, respectively, if the number of 1s in the resultant matrix is equal to the column weight of the LDPC matrix; and
correcting the codeword by changing a binary value of the bit number of the code word vector corresponding to the identified column number of the LDPC matrix.

17. The method of claim 16, further comprising:
ending the method without correcting the error if the number of 1s in the resultant matrix is not equal to the column weight of the LDPC matrix.

18. The method of claim 16, further comprising:
ending the method without correcting the error if no column of the LDPC matrix has bit values corresponding to the bit values of the resultant matrix.

19. The method of claim 16, further comprising:
generating a second resultant matrix by performing another XOR operation and another modular 2 operation with respect to the LDPC matrix and the corrected code word vector; and
determining that the error has been corrected if all bits of the second resultant matrix have a zero value.
